(19) United States
(12) Patent Application Publication
(10) Pub. No.: US 2025/0095646 A1
(43) Pub. Date: Mar. 20, 2025

(54) AUTOMATIC REPLACEMENT OF TARGETED OBJECTS WITHIN ARBITRARY MEDIA

(71) Applicant: International Business Machines Corporation, Armonk, NY (US)

(72) Inventors: Hessel Tuinhof, Dublin (IE); Marco Simioni, Pisa (IT); Killian Levacher, Dublin (IE); Stefano Braghin, Dublin (IE)

(21) Appl. No.: 18/470,061

(22) Filed: Sep. 19, 2023

(51) Int. Cl. G10L 15/22; G10L 13/033; G10L 15/08; G10L 15/26

(52) U.S. Cl. CPC G10L 15/22; G10L 13/033; G10L 15/08; G10L 15/26; G10L 2015/088

(57) ABSTRACT

In an approach to improve the protection of sensitive data, embodiments extract, by a signal separator component, a voice from an audio file, and transcribe, by a speech-to-text component, the voice in the audio file into text. Further, embodiments identify, by a natural language processing and identification component, sensitive data in the text, wherein identifying sensitive date comprises parsing the text and identifying the sensitive data contained within the text. Additionally, embodiments identify, by a voice locator component, a synthetic voice that matches the voice from the audio file, replace, by a voice replacer component, the identified sensitive data with synthetic data that is semantically and contextually meaningful, wherein the synthetic data is voiced using the synthetic voice, and output a new audio file with the sensitive data replaced by the synthetic data.

### BACKGROUND OF THE INVENTION

The present invention relates generally to privacy and security, and more particularly to the field of generative models and artificial intelligence (AI) to replace targeted noise.

Generative AI refers to deep-learning models that can generate high-quality text, images, and other content based on the data they were trained on. Generative AI refers to deep-learning models that can take raw data and “learn” to generate statistically probable outputs when prompted. At a high level, generative models encode a simplified representation of their training data and draw from it to create a new work that's similar, but not identical, to the original data. Generative models have been used for years in statistics to analyze numerical data. The rise of deep learning, however, made it possible to extend them to images, speech, and other complex data types. A generative adversarial network (GAN) is a class of machine learning framework and a prominent framework for approaching generative AI. In a GAN, two neural networks contest with each other in the form of a zero-sum game, where one agent's gain is another agent's loss. Given a training set, this technique learns to generate new data with the same statistics as the training set. For example, a GAN trained on photographs can generate new photographs that look at least superficially authentic to human observers, having many realistic characteristics. Though originally proposed as a form of generative model for unsupervised learning, GANs have also proved useful for semi-supervised learning, fully supervised learning, and reinforcement learning. The use of generative models and AI have led to creation and utilization of Deepfake technology. Deepfakes are synthetic media that have been digitally manipulated to replace one person's likeness convincingly with that of another.

### SUMMARY

Embodiments of the present invention disclose a computer-implemented method, computer system, and computer program product for improving the security of sensitive data, the computer-implemented method comprises: extracting, by a signal separator component, a voice from an audio file; transcribing, by a speech-to-text component, the voice in the audio file into text; identifying, natural language processing and identification component, sensitive data in the text, wherein identifying sensitive date comprises: parsing the text and identifying the sensitive data contained within the text; identifying, by a voice locator component, a synthetic voice that matches the voice from the audio file; replacing, by a voice replacer component, the identified sensitive data with synthetic data that is semantically and contextually meaningful, wherein the synthetic data is voiced using the synthetic voice; and outputting a new audio file with the sensitive data replaced by the synthetic data.

### BRIEF DESCRIPTION OF THE DRAWINGS

FIG. 1 is a functional block diagram illustrating a distributed data processing environment, a program, in accordance with an embodiment of the present invention;

FIG. 2 illustrates a functional block diagram and operational steps of the program, on a server computer within the distributed data processing environment of FIGS. 1, in accordance with an embodiment of the present invention;

FIG. 3 illustrates operational steps of the program, on a server computer within the distributed data processing environment of FIGS. 1, for automatically replacing voiced sensitive data, in accordance with an embodiment of the present invention.

### DETAILED DESCRIPTION

Embodiments of the present invention recognize that audio content represents a vast amount of data in which sensitive data (e.g., personal information (PI)) is shared nowadays as part of customer agent interactions. Further, embodiments of the present invention recognize that these conversations are generally recorded and saved as audio files with sensitive data contained within the audio files. Embodiments of the present invention recognize that when sensitive data detection and protection measures are utilized to protect customer data within such files, current approaches simply replace such utterances by an audio tone (e.g., beep). Embodiments of the present invention recognize that current approaches, in the art, at a minimum affects the natural flow of the conversation but in most cases the current approaches prevent any meaningful understanding of the conversation that has occurred since key elements of the conversation (names, date of birth, etc.) are removed.

Embodiments of the present invention improve the art and solve, at least, the issues above by protecting the sensitive data contained within an audio file conversation while providing the minimum deterioration of the original conversation to the listener, wherein the produced or output audio consists of the original recorded audio without any modifications so the playback of the audio to a third-party listener is seamless. More specifically, embodiments of the present invention improve the art and solve, at least, the issues above by executing an automated replacement of targeted speech sections within audio content comprising sensitive data by (i) receiving full audio speaker content containing sections of uttered personal information as query input, (ii) replacing audio content with sections of voice originally uttering personal information with a near identical synthetic voice uttering the same sentence without any personal information, and (iii) utilizing generative audio models, or any text-to-speech model to have control over the audio speaker characteristics. Sensitive data may comprise PI, confidential information, industrial secrets, general information a user wishes to keep confidential, and/or any general or sensitive information, for which a detector can be created. Various embodiments of the present invention comprise an “Opt-in” feature to enable its functions and operations.

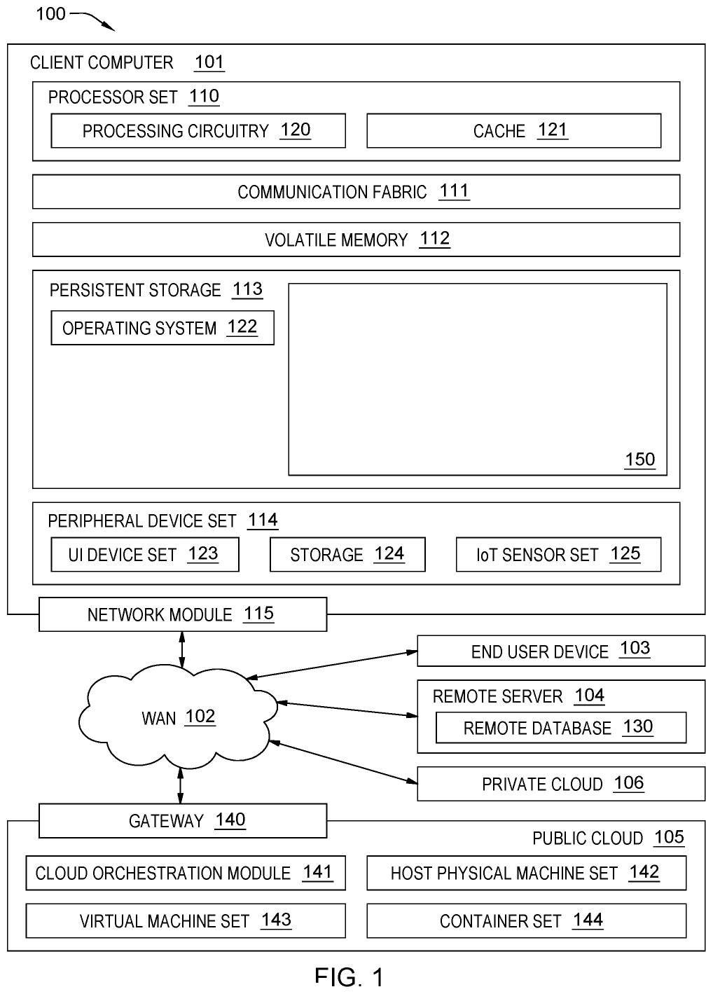

Implementation of embodiments of the invention may take a variety of forms, and exemplary implementation details are discussed subsequently with reference to the Figures (i.e., FIG. 1-FIG. 3).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as program (component) 150. In addition to component 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, a virtual reality headset, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Component 150 may improve the art and solve, at least, the issues above by protecting the sensitive data contained within an audio file conversation while providing the minimum deterioration of the original conversation to the listener, wherein the produced or output audio consists of the original recorded audio without any modifications so the playback of the audio to a third-party listener is seamless. More specifically, component 150 may improve the art and solve, at least, the issues above by executing an automated replacement of targeted speech sections within audio content comprising sensitive data by (i) receiving full audio speaker content containing sections of uttered personal information as query input, (ii) replacing audio content with sections of voice originally uttering personal information with a near identical synthetic voice uttering the same sentence without any personal information, and (iii) utilizing generative audio models, or any text-to-speech model to have control over the audio speaker characteristics. Sensitive data may comprise PI, confidential information, industrial secrets, general information a user wishes to keep confidential, and/or any general or sensitive information, for which a detector can be created.

Component 150 may (i) receive as input: full audio speaker content containing sections in which sensitive data is present (e.g., uttered), knowledge base, query input configuration, (ii) return as output audio content with sections of voice originally uttering sensitive data replaced with a near identical synthetic voice uttering the same sentence without any sensitive data, and utilizing generative audio models, speech to text modules, audio signal separators, knowledge base, and voice tuner to generate and output seamless audio content without the sensitive data present in the audio. In various embodiments, component 150 removes the sensitive data and replaces the sensitive data with filler words that match the context of the audio and the speakers voice by utilizing the generative audio models, speech to text modules, audio signal separators, knowledge base, and/or voice tuner.

In various embodiments, component 150 executes automated identification and replacement of user defined arbitrary objects (i.e., sensitive data) contained within audio files. Component 150 may replace identified sensitive data with semantically meaningful replacements (e.g.: replacing the name of an individual with different identifying name of the individual, the numbers of a credit card with an equivalent set of random numbers, etc.).

In various embodiments, component 150 generates and outputs speech that sounds like the original speaker, wherein the generated and output speech (synthesized speech) replaces the identified sensitive data with a generic equivalent using a synthesized voice that sounds like the voice of the original speaker to avoid listeners detecting any changes. In various embodiments, component 150 edits the audio file by removing the identified sensitive data from the audio file and replacing the removed sensitive data with the generated and output synthesized speech. In other embodiments, component 150 overlays the synthesized speech over the identified sensitive data. In other embodiments, component 150 may mute the portions of the audio file containing the identified sensitive data and inserting the synthesized speech over the muted portions of the audio file. In various embodiments, component 150 may distort the portions of the audio file containing the identified sensitive data with implement the synthesized speech so that the synthesized speech is blended seamlessly in the audio file.

In various embodiments, component 150 removes the sensitive data by either muting the audio for the identified time window, or by replacing the sound waves of the person saying the identified sensitive information, thus preserving the background noise. In other embodiments, component 150 removes the sensitive data by replacing the sensitive data with noise during the identified time window (e.g., adding noise) while preserving the background noise/sound, wherein component 150 leverages generative models to recreate sound information of the same duration that conveys a different message (i.e., not sensitive). In other embodiments, component 150 removes the sensitive data by replacing the sensitive data with masked or anonymized information.

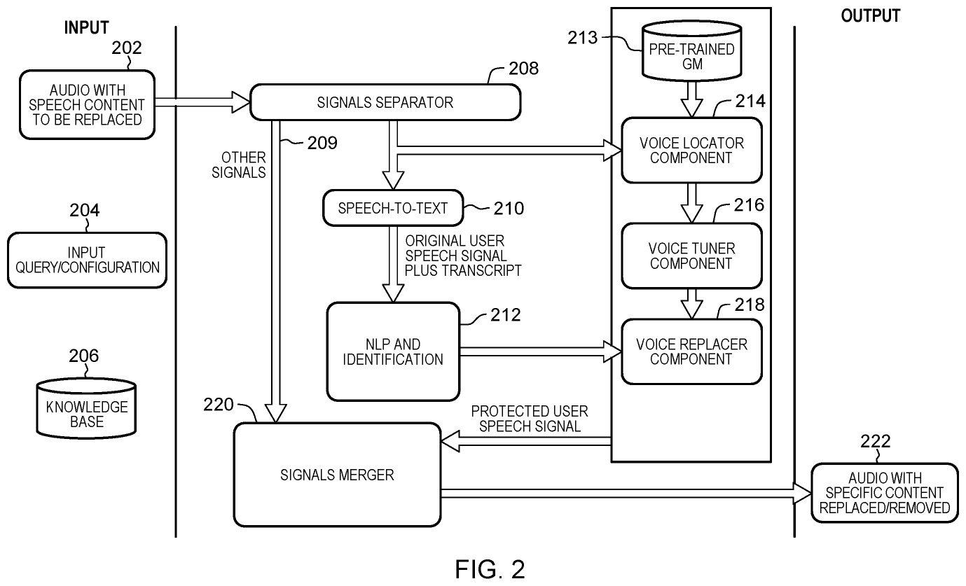

FIG. 2 is a functional block diagram illustrating a distributed data processing environment, in accordance with one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, component 150 receives an audio file with editable speech content 202. In various embodiments, component 150 receives an audio file with editable speech content, wherein the audio file editing utilizes input query and configuration parameters 204, knowledge base 206. For example, a user inputs an audio file with speech content to be replaced by utilizing knowledge based 206 and input query configuration parameters 204, wherein, knowledge base 206 comprises a knowledge corpus of sensitive data (e.g., banned words), and wherein and input query configuration parameters 204 comprise parameters for determining whether identified sensitive data should be masked or replaced with synthesized speech. In some embodiments, knowledge base 206 consist of a database or alternatively could consist in a linked data semantic graph. In various embodiments, knowledge base 206 is a knowledge base as it is known and understood in the art.

In the depicted embodiment, component 150 processes, by signal separator component 208, the received audio file. In various embodiments, component 150 processes, by signal separator component 208, the received audio file, wherein the signal separator component extracts the one or more voices from the audio and outputs one or more voice audio files, wherein each of the one or more audio files comprise a voice audio associated with an individual. In the depicted embodiment, other signals 209 are sent to signals merger 220. In the depicted embodiment, component 150 transcribes, via speech-to-text component 210, the voice audio in the audio file into text. In the depicted embodiment, component 150, via natural language processor (NLP) and identification component 212, parses the text and identifies any present sensitive data contained within that text, wherein the sensitive data is predetermined. NLP and identification component 212 may tag and categorize the original user's speech signal, transcript, and/or sensitive words. In various embodiments, NLP, and identification component 212 marks the tagged and categorized sensitive words in the text with a timestamp associated with the sensitives word's location in the audio file. NLP and identification component 212 may utilize any named entity recognition (NER) identification algorithm known and used in the art. In other embodiments, component 150, via NLP and identification component 212, processes the audio in the received audio file and transcribes the audio into text and/or a text file (e.g., generates a transcript of the audio file). Component 150 may utilize the text to identify sensitive data in the audio file and/or text and may utilize the text to create replacement text for the identified sensitive data that is both context and semantic dependent (e.g., replace a person's name with another person's name, with the same “fictitious” relationships as the rest of the context).

In the depicted embodiment, component 150, via voice locator component 214, processes the one or more voice audio files. In various embodiments, component 150, via voice locator component 214, processes the one or more identified and extracted voices from the received audio file. Voice locator component 214 may identify, for instance within the manifold of a pre-trained GAN that synthetizes voices (e.g., pre-trained generative model (GM) 213), the closest synthetic voice available that matches an extracted voice from the received audio file, wherein the closest synthetic voice match is determined based on predetermined metrics and/or thresholds. In various embodiments, voice locator component 214 locates the closest matching synthetic voice in the pre-trained GM component 213 and outputs a synthetic voice that matches, within a predetermined threshold of acceptance, an original voice extracted from the audio file.

In the depicted embodiment, component 150, via voice tuner component 216, dynamically tunes the identified and/or output synthetic voice, wherein the synthetic voice is dynamically tuned until the synthetic voice is within a predetermined threshold of acceptance of similarity associated with the original voice. In various embodiments, voice tuner component 216 fine tunes the selected and/or output synthetic voice in a manner so that the synthetic voice matches the voice of the user within a predetermined threshold, wherein fine tuning comprises adjusting the pitch, audio, quality, volume, speed, length, and/or any other acoustic, articulatory, and/or aerodynamic features known and understood in the art to adjust the features of a voice.

In the depicted embodiment, component 150, via voice replacer component 218, utilizes the fine-tuned synthetic voice, and replaces the identified data with synthetic data that is semantically and contextually meaningful. Semantically meaningful may mean that if the sensitive data identified were for example (i) a first name (e.g., Mary), (ii) a surname (e.g., Dwyer), (iii) age (e.g., 55 years old), (iv) occupation (e.g., a journalist), you want to make sure that the sensitive data was replaced with an item of the same category. For example, first name Mary would be replaced by another first name (ideally of the same categorized gender) and not to be replaced by an occupation. This way the original semantics of the original sentence is preserved. For example, “Mary is a journalist of 55 years old” would be replaced with “Tracy is a financial analyst of 25 years old.”

In various embodiments, voice replacer component 218 utilizes the identified sensitive data from the generated text from NLP and identification component 212 to identify replacements within the knowledge base and output a list of replacement options for the identified sensitive data. A replacement refers to a replacement that substitutes identified sensitive data while preserving the semantics of the sentence. For example, if component 150 finds the name “Mary” to be sensitive data (i.e., list of sensitive data replacements), then component 150, via voice replacer component 218, replaces “Mary” with the name “Jane” in the audio file so that the synthetic voice matches the voice of the individual saying “Mary.” In another example, if a credit card number is identified, then component 150 replaces the identified credit card number with a random number of the same form. In the depicted embodiment, voice replacer component 218 ingests the tuned synthetic voice, list of identified sensitive data, a list of sensitive data replacements, and the original extracted voice of the user (e.g., speaker) and outputs a new audio file with voiced sensitive data replaced by the equivalent sensitive data replacements voiced using the synthetic voice.

In the depicted embodiment, signals merger 220 receives the new audio file as input from voice replacer component 218 and merges the new audio file with the original background audio in the audio file (e.g., original audio file). In various embodiments, component 150, via signals merger 220, outputs updated audio and audio file 222, wherein updated audio and audio file 222 comprises audio with specific content replaced and/or removed. In various embodiments, component 150 executes the updated audio file, wherein the executed audio file outputs an updated audio, wherein the updated audio plays the recorded conversation of the user; however, the identified sensitive data is replaced with context relevant terms, words, numbers, and/or phrases in a synthetic voice that is identical, within a predetermined value or threshold, to the original voice.

For example, a user named Alice calls TelCo's customer service, wherein an Automated voice answers the call and states “Our agent will be with you shortly. Please note all calls are recorded for training and quality purposes.” In this example, subsequently, an Agent answers the call, and recording of the call begins, wherein the Agent says “Hello, my name is Bob, could you please confirm your name and date of birth.” In this example, Alice receives real-time audio, and a recorder records the real-time audio (i.e., original audio), wherein the real-time audio comprises sensitive data uttered by both the agent and Alice. Continuing the example, Alice response by saying “Sure, my name is Alice, and I was born on the 17th of February 1982.”

In this example, the predetermined sensitive data is established to be personal information such as, among other things, names, and birthdays of participants. Therefore, component 150 replaces the identified names and birthdays in the record conversation with contextual relevant replacements by muting or cutting the portion of the audio with the identified sensitive data with a synthetic voice that fills in the identified sensitive data with the contextual relevant replacement, and wherein the synthetic voice matches the voice of the user. Continuing the example with Alice, component 150 takes the conversation and manipulates the audio to generate and output “Hello, my name is Charlie, could you please confirm your name and date of birth?” and “Sure, my name is Eve, and I was born on the 1st of November 1981.” Note the name “Bob” was replaced by a synthetic voice saying “Charlie,” wherein the synthetic voice resembles the agent's real voice. Further, the name “Alice” was replaced by a synthetic voice saying “Eve” and the date “17th of February 1982” was replaced by a synthetic voice saying, “1 st of November 1981,” wherein the synthetic voice resembles the customer's real voice. In various embodiments, at least a portion of the original audio comprising the sensitive data is imperceptible in the output updated audio comprising the synthetic voice replacement sensitive.

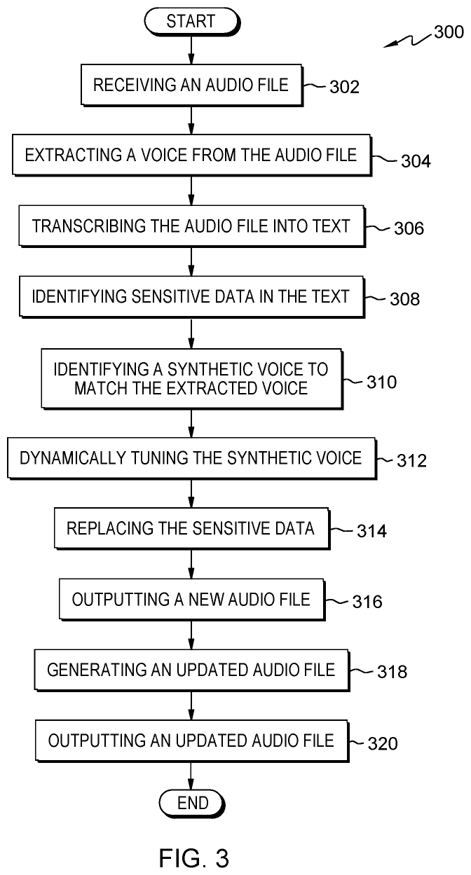

FIG. 3 illustrates operational steps of component 150, generally designated 200, in communication with client computer 101, remote server 104, private cloud 106, EUD 103, and/or public cloud 105, within distributed data processing environment 100, for automatically replacing voiced sensitive data, in accordance with an embodiment of the present invention. FIG. 3 provides an illustration of one implementation and does not imply any limitations with regard to the environments in which different embodiments may be implemented. Many modifications to the depicted environment may be made by those skilled in the art without departing from the scope of the invention as recited by the claims.

In block 302, component 150 receives an audio file. In various embodiments, component 150 receives an audio file with editable speech content. In various embodiments, component 150 receives an audio file with editable speech content, wherein the audio file editing utilizes and input query and configuration and a knowledge base.

In block 304, component 150 extracts a voice from the audio file. In various embodiments, component 150 processes, by a signal separator component, the received audio file, wherein the signal separator component extracts the one or more voices from the audio and outputs one or more voice audio files, wherein each of the one or more audio files comprise a voice audio associated with an individual.

In block 306, component 150 transcribes the audio file into text. In various embodiments, component 150 transcribes, via a speech-to-text component, the voice audio in the audio file into text.

In block 308, component 150 identifies sensitive data in the text. In various embodiments, component 150, via an NLP and identification component, parses the text and identifies any present sensitive data contained within the text, wherein the sensitive data is predetermined. Component 150, via the NLP and identification component, may tag and categorize the original user's speech signal, transcript, and/or sensitive words. In various embodiments, NLP, and identification component 212 marks the tagged and categorized sensitive words in the text with a timestamp associated with the location of the sensitive words in the audio file.

In block 310, component 150 identifies a synthetic voice to match the extracted voice. In various embodiments, component 150, via the voice locator component, processes the one or more voice audio files. In various embodiments, component 150, via the voice locator component, processes the one or more identified and extracted voices from the received audio file. Voice locator component 214 may identify, for instance within the manifold of a pre-trained GAN that synthetizes voice the closest synthetic voice available that matches an extracted voice from the received audio file, wherein the closest synthetic voice match is determined based on predetermined metrics and/or thresholds. In various embodiments, the voice locator component locates the closest matching synthetic voice in a pre-trained GM component and outputs a synthetic voice that matches an original voice extracted from the audio file.

In block 312, component 150 dynamically tunes the synthetic voice. In various embodiments, component 150, via a voice tuner component, dynamically tunes the identified and/or output synthetic voice, wherein the synthetic voice is dynamically tuned until the synthetic voice is within a predetermined threshold of acceptance of similarity associated with the original voice. In various embodiments, the voice tuner component fine tunes the selected and/or output synthetic voice in a manner so that the synthetic voice matches the voice of the user within a predetermined threshold, wherein fine tuning comprises adjusting the pitch, audio, quality, volume, speed, length, and/or any other acoustic, articulatory, and/or aerodynamic features known and understood in the art to adjust the features of a voice.

In block 314, component 150 replaces the sensitive data in audio. In various embodiments, component 150, via a voice replacer component, utilizes the fine-tuned synthetic voice to replace the identified sensitive data with synthetic data that is semantically and contextually meaningful. Synthetic data is generated data that is contextually and semantically similar to the identified sensitive data. In various embodiments, the voice replacer component utilizes the identified sensitive data from the generated text from the NLP and identification component to identify replacements within the knowledge base and outputs a list of replacements for the identified sensitive data. For example, if component 150 finds the name “Joe” to be sensitive data (i.e., list of sensitive data replacements), then component 150, via the voice replacer component 218, replaces “Joe” with the name “Phil” in the audio file so that the synthetic voice matches the voice of the individual saying “Joe.” In another example, if a phone number is identified, then component 150 replaces the identified phone number with a random phone number of the same form.

In block 316, component 150 outputs a new audio file. In various embodiments, component 150, via the voice replacer component, ingests the tuned synthetic voice, list of identified sensitive data, a list of sensitive data replacements, and the original extracted voice of the user (e.g., speaker) and outputs a new audio file with voiced sensitive data replaced by the equivalent sensitive data replacements voiced by the synthetic voice.

In block 318, component 150 generates an updated audio file. In various embodiments, component 150, via a signals merger, generates an updated audio file by receiving the new audio file as input from voice replacer component 218 and merging the new audio file with the original background audio in the audio file (e.g., original audio file).

In block 320, component 150 outputs an updated audio file. In various embodiments, component 150, the signals merger 220, outputs an updated audio and audio file, wherein the updated audio and audio file comprises audio with specific content replaced and/or removed. In various embodiments, component 150 executes the updated audio file, wherein the executed audio file outputs an updated audio, wherein the updated audio plays the recorded conversation of the user; however, the identified sensitive data is replaced with context relevant terms, words, numbers, and/or phrases in a synthetic voice that is identical, within a predetermined value or threshold, to the original voice.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
extracting, by a signal separator component, a voice from an audio file;
transcribing, by a speech-to-text component, the voice in the audio file into text;
identifying, by a natural language processing and identification component, sensitive data in the text, wherein identifying sensitive date comprises:
parsing the text and identifying the sensitive data contained within the text;
identifying, by a voice locator component, a synthetic voice that matches the voice from the audio file;
replacing, by a voice replacer component, the identified sensitive data with synthetic data that is semantically and contextually meaningful, wherein the synthetic data is voiced using the synthetic voice; and
outputting a new audio file with the sensitive data replaced by the synthetic data.

2. The computer-implemented method of claim 1, further comprising:
receiving an audio file with editable speech content, wherein audio file editing utilizes an input query, configuration, and a knowledge base.

3. The computer-implemented method of claim 1, further comprising:
tagging and categorizing an original user's speech signal, transcript, and/or sensitive words; and
marking the tagged and categorized sensitive words in the text with a timestamp associated with a location of the sensitive words in the audio file.

4. The computer-implemented method of claim 1, further comprising:
identifying, within a manifold of a pre-trained generative adversarial network (GAN) that synthetizes the voice, the synthetic voice that matches the voice from the audio file, wherein the synthetic voice that matches the voice from the audio file is determined based on predetermined metrics.

5. The computer-implemented method of claim 1, further comprising:
dynamically tunning, by a voice tuner component, the synthetic voice, wherein the synthetic voice is dynamically tuned until the synthetic voice is within a predetermined threshold of acceptance of similarity associated with the voice from the audio file.

6. The computer-implemented method of claim 1, further comprising:
utilizing the sensitive data from the text to identify replacements for the sensitive data within a knowledge base; and
outputting a list of replacement options for the identified sensitive data.

7. The computer-implemented method of claim 1, further comprising:
merging the new audio file with the audio file to generate an updated audio file; and
outputting the updated audio file, wherein the updated audio file comprises audio with the sensitive data replaced with synthetic data voice by the synthetic voice.

8. A computer system comprising:
one or more computer processors;
one or more computer readable storage devices;
program instructions stored on the one or more computer readable storage devices for execution by at least one of the one or more computer processors, the stored program instructions comprising:
program instructions to extract, by a signal separator component, a voice from an audio file;
program instructions to transcribe, by a speech-to-text component, the voice in the audio file into text;
program instructions to identify, by a natural language processing and identification component, sensitive data in the text, wherein identifying sensitive date comprises:
program instructions to parse the text and identifying the sensitive data contained within the text;
program instructions to identify, by a voice locator component, a synthetic voice that matches the voice from the audio file;
program instructions to replace, by a voice replacer component, the identified sensitive data with synthetic data that is semantically and contextually meaningful, wherein the synthetic data is voiced using the synthetic voice; and
program instructions to output a new audio file with the sensitive data replaced by the synthetic data.

9. The computer system of claim 8, further comprising:
program instructions to receive an audio file with editable speech content, wherein audio file editing utilizes an input query, configuration, and a knowledge base.

10. The computer system of claim 8, further comprising:
program instructions to tag and categorize an original user's speech signal, transcript, and/or sensitive words; and
program instructions to mark the tagged and categorized sensitive words in the text with a timestamp associated with a location of the sensitive words in the audio file.

11. The computer system of claim 8, further comprising:
program instructions to identify, within a manifold of a pre-trained generative adversarial network (GAN) that synthetizes the voice, the synthetic voice that matches the voice from the audio file, wherein the synthetic voice that matches the voice from the audio file is determined based on predetermined metrics.

12. The computer system of claim 8, further comprising:
program instructions to dynamically tune, by a voice tuner component, the synthetic voice, wherein the synthetic voice is dynamically tuned until the synthetic voice is within a predetermined threshold of acceptance of similarity associated with the voice from the audio file.

13. The computer system of claim 8, further comprising:
program instructions to utilize the sensitive data from the text to identify replacements for the sensitive data within a knowledge base; and
program instructions to output a list of replacement options for the identified sensitive data.

14. The computer system of claim 8, further comprising:
program instructions to merge the new audio file with the audio file to generate an updated audio file; and
program instructions to output the updated audio file, wherein the updated audio file comprises audio with the sensitive data replaced with synthetic data voice by the synthetic voice.

15. A computer program product comprising:
one or more computer readable storage devices and program instructions stored on the one or more computer readable storage devices, the stored program instructions comprising:
program instructions to extract, by a signal separator component, a voice from an audio file;
program instructions to transcribe, by a speech-to-text component, the voice in the audio file into text;
program instructions to identify, by a natural language processing and identification component, sensitive data in the text, wherein identifying sensitive date comprises:
program instructions to parse the text and identifying the sensitive data contained within the text;
program instructions to identify, by a voice locator component, a synthetic voice that matches the voice from the audio file;
program instructions to replace, by a voice replacer component, the identified sensitive data with synthetic data that is semantically and contextually meaningful, wherein the synthetic data is voiced using the synthetic voice; and
program instructions to output a new audio file with the sensitive data replaced by the synthetic data.

16. The computer program product of claim 15, further comprising:
program instructions to receive an audio file with editable speech content, wherein audio file editing utilizes an input query, configuration, and a knowledge base.

17. The computer program product of claim 15, further comprising:
program instructions to tag and categorize an original user's speech signal, transcript, and/or sensitive words; and
program instructions to mark the tagged and categorized sensitive words in the text with a timestamp associated with a location of the sensitive words in the audio file.

18. The computer program product of claim 15, further comprising:
program instructions to identify, within a manifold of a pre-trained generative adversarial network (GAN) that synthetizes the voice, the synthetic voice that matches the voice from the audio file, wherein the synthetic voice that matches the voice from the audio file is determined based on predetermined metrics.

19. The computer program product of claim 15, further comprising:
program instructions to dynamically tune, by a voice tuner component, the synthetic voice, wherein the synthetic voice is dynamically tuned until the synthetic voice is within a predetermined threshold of acceptance of similarity associated with the voice from the audio file.

20. The computer program product of claim 15, further comprising:
program instructions to utilize the sensitive data from the text to identify replacements for the sensitive data within a knowledge base;
program instructions to output a list of replacement options for the identified sensitive data;
program instructions to merge the new audio file with the audio file to generate an updated audio file; and
program instructions to output the updated audio file, wherein the updated audio file comprises audio with the sensitive data replaced with synthetic data voice by the synthetic voice.
